(19) United States
(12) Patent Application Publication
(10) Pub. No.: US 2023/0134617 A1
(43) Pub. Date: May 4, 2023

(54) Device and Process for Heating of Foods

(71) Applicant: Deutsches Institut für Lebensmitteltechnik e.V., Quakenbrück (DE)

(72) Inventors: Volker Heinz, Quakenbrück (DE); Martin Stute, Quakenbrück (DE)

(21) Appl. No.: 17/971,864

(22) Filed: Oct. 24, 2022

(30) Foreign Application Priority Data
Oct. 22, 2021 (DE) 102021211949.2

(51) Int. Cl. H05B 3/00; G01N 27/06; A23L 13/60; A23L 5/10; A23L 5/30

(52) U.S. Cl. CPC H05B 3/0004; H05B 3/0014; G01N 27/06; A23L 13/65; A23L 5/10; A23L 5/30

(57) ABSTRACT

A device having a first electrode and a second electrode arranged at a distance therefrom along the surface of the workpiece. At least the first electrode is arranged at a distance from the workpiece, which is preferably a foodstuff, and the distance is filled and bridged by a conductive liquid. The conductive liquid projects over the first electrode and the second electrode and establishes electrical contact of each electrode with the workpiece. The conductive liquid has the advantage, e.g. compared to a rigid contact surface, that an electrical contact is established independently of the surface shape of the workpiece, without the electrode itself having to be in contact with the workpiece.

### PRIORITY CLAIM AND REFERENCE TO RELATED APPLICATION This application claims the priority of German patent application 10 2021 211 949, filed on 22 Oct. 2021.

### BACKGROUND

WO 2019/134837 A1 describes that electrodes are pierced through the casing into sausage and through the sausage meat and are supplied with current.

WO 2018/091557 A1 describes electrodes in the form of a comb that are pierced into sausage and to which current is applied.

### SUMMARY OF THE INVENTION

A preferred embodiment is a device for heating at least one workpiece by applying an electric current to at least one workpiece through two electrodes, A first electrode us arranged at a distance from a first end of the at least one workpiece, which is preferably a foodstuff arranged in a conductive casing. The distance is bridged by a conductive liquid. A second electrode is arranged at the second end of the at least one workpiece opposite to its first end along its longitudinal axis. The conductive liquid has a conductivity which deviates from the conductivity of the workpiece by at maximum 75%, preferably by at maximum 50%.

### BRIEF DESCRIPTION OF THE DRAWINGS

The invention will be explained in more detail with reference to the figures, which schematically show preferred embodiments of the device, and of which:.

FIG. 1 is a schematic diagram of a preferred device for heating that is holding a sausage-shaped foodstuff representative of a workpiece;

FIG. 2 is a schematic diagram of a preferred device for heating that is holding a sausage—in a vertical arrangement;

FIG. 3 is a schematic diagram of a preferred device for heating with electrodes arranged at a distance from one another and a foodstuff is arranged between the electrodes at a distance from the electrodes.

### DETAILED DESCRIPTION OF THE PREFERRED EMBODIMENTS

The present invention relates to a device, the use of the device and a method which can be carried out therewith for heating workpieces, in particular foodstuffs, by means of current flow, also referred to as ohmic heating. The workpieces, hereinafter also referred to as foodstuffs by way of representation, preferably have an elongated shape, for example with a length which is greater than the diameter by a factor of at least 2 or at least 3. The workpieces, in particular foodstuffs, extend along their longitudinal axis from their first end to their opposite second end. The foodstuffs optionally are without a casing, preferably in a casing. In an embodiment, the foodstuff may be an uncooked food mass, e.g. sausage meat, disposed in a casing or in an electrically non-conductive container. Foodstuffs preferably comprise a mass with or made of mixed plant and/or animal ingredients, e.g., mixed masses based on plant proteins and/or sausage meat. Preferred foodstuffs are sausage or sausage-shaped masses with or made of plant proteins, preferably contained in a casing.

The device has the advantage of enabling a process that heats workpieces, in particular foodstuffs, in an energy-efficient and rapid manner, in particular rapidly over its entire cross-section. A further advantage is that the device is set up to leave the surface of workpieces, in particular foodstuffs, in particular their casing, undamaged and, for example, not to perforate the surface, especially a casing.

Workpieces can also be made of any material as long as they are electrically conductive, e.g. of metal and/or of electrically conductive plastic.

The invention has the object of providing an alternative device and an alternative method for heating workpieces, in particular foodstuffs, which are preferably suitable for not damaging the surface of the workpieces, in particular a casing or, in the case of casingless foodstuffs, a surface consisting of food mass.

The invention achieves the object by the features of the claims and in particular provides a device comprising a first electrode and a second electrode to be arranged with a spacing therefrom along the surface of the workpiece, of which at least the first electrode, optionally both electrodes, are set up to be arranged at a distance from the workpiece, which is preferably a foodstuff, and set up for the distance to be filled and bridged by a conductive liquid, which is preferably water. Therein, the first electrode is preferably arranged at a first end of the workpiece and the second electrode is arranged at a second end of the workpiece opposite to the first end along its longitudinal axis. Accordingly, the workpiece extends along its longitudinal axis between its first end and its second end. Preferably, the workpiece is a foodstuff, in particular an uncooked food mass, which is preferably contained in an electrically conductive casing. In an embodiment, the electrodes are spaced apart at opposite ends of a container, also referred to as a storage container, such that the container is adapted to receive the workpiece between the electrodes with at least one electrode spaced apart from the workpiece, and the container is adapted to receive electrically conductive fluid filling the distance between the electrodes and the workpiece. In this embodiment, during the process the workpiece lies in the container and is subjected to electric current from the electrodes at its opposite ends along its longitudinal axis. In this embodiment, the device is adapted for use, for example, as a device for heating differently shaped workpieces in succession, since in each case the fluid makes electrical contact of the workpiece to the electrodes. The container can be formed as an electrically non-conductive container and can have one of the electrodes each arranged terminally. Optionally, the container is open along one longitudinal side.

The conductive liquid protrudes over the first electrode and the second electrode so that the conductive liquid bridges the distance between each electrode and the workpiece, and is arranged to establish an electrical contact of each electrode with a workpiece, which is in particular a foodstuff Therein, the conductive liquid has the advantage, for example compared to a rigid contact surface, that an electrical contact is established regardless of the surface shape of the workpiece, without the electrode itself having to be in contact with the workpiece. Optionally, the first electrode is arranged to renew the conductive liquid continuously or batchwise and comprises a conveying device for conveying conductive liquid continuously or batchwise to the first electrode, e.g. to the area by which the first electrode is to be arranged at a distance from the workpiece. In general, the device or method is set up to arrange workpieces individually between a first electrode and a second electrode and to heat them individually by means of current flow, in particular by means of so-called ohmic heating. The device and method are optionally set up to arrange each workpiece individually between two electrodes. In an embodiment, in which a container, at each of whose ends opposite along its longitudinal axis one of the electrodes is arranged, the container is arranged to receive at least one workpiece, optionally exactly 1 workpiece, further optionally at least two workpieces in parallel, each arranged with the longitudinal axis of the workpiece parallel to the longitudinal axis of the container and/or with the ends opposite along the longitudinal axis of the workpiece facing one of the electrodes. The conductive liquid that fills the distance between the first electrode and the foodstuff is conveyed by a conveying device into the distance between the first electrode and the foodstuff so that the liquid brings the first electrode into electrical contact with the foodstuff. The device is arranged to convey the liquid as a free continuous stream contacting the first electrode.

In general, it is preferred that a storage container for the conductive fluid is electrically insulated and connected to the first electrode by a feed line, which is preferably non-conductive. In this embodiment, the conveying device is adapted to provide a continuous stream of fluid that projects over the electrode. The electrode, which is preferably made of metal, may be, for example, a pipe or pipe cap connected to the feed line or forming a section of the feed line for the fluid. Alternatively, the electrode, hollow or solid, can be enclosed by a spaced tube, e.g. made of metal or of insulating material, the space between the electrode and the tube forming a feed line for the conductive fluid. The conveying device may be a pump or the arrangement of a storage container for the liquid above the electrode and/or pressurization of the storage container, e.g. with compressed air or a loaded pressure piston.

In a further embodiment, the conductive liquid filling the distance between the electrode and the workpiece, which is in particular a foodstuff, is retained at least in part by a porous material which is, for example, a fabric, sponge and/or a liquid-permeable, preferably elastic, casing which retains a portion of the liquid and has a surface wetted with the liquid. Such a casing is e.g. attached to the electrode, for example, preferably covers its surface facing the workpiece, and further preferably the space between the casing and the electrode is connected to the feed line. The porous material that is filled with conductive fluid is disposed in the distance between the electrode and the foodstuff, so that the conductive fluid brings the electrode into electrical contact with the foodstuff. The porous material and/or the casing may be an insulating material whose porosity is filled with the conductive liquid. The casing may be, for example, a porous fabric, a grid, e.g. made of metal or of plastic, a non-woven fabric or porous film, arranged from the electrode at a distance that is filled with conductive liquid, e.g. terminally projecting over the electrode. Preferably, conductive liquid is conveyed continuously or batchwise into the porous material and/or between the liquid-permeable casing and the electrode. This embodiment has the advantage that the porous material and/or a liquid-permeable casing between the workpiece and the electrode adapts to the surface of the workpiece and establishes an electrical contact without the electrode having to be adapted to the workpiece surface and without direct contact and without the electrode damaging the surface of the workpiece.

In general, it is preferred that the conductive liquid has a conductivity that deviates by at most 50% from the conductivity of the foodstuff, e.g. is lower than the conductivity of the foodstuff, and in particular is higher than the conductivity of the foodstuff, or is equal to the conductivity of the foodstuff. Preferably, the conductive liquid is water, the conductivity of which is optionally adjusted by removing or adding salt, in particular NaCl. For control of the conductivity of the liquid, the device may comprise a conductivity sensor, e.g. placed in the conduit for liquid connected to an electrode, and preferably a dosing device controlled depending on the signal of the conductivity sensor for the addition of salt, brine or water, which may be demineralized. The dosing device can, for example, discharge into the conduit for liquid, into a storage container and/or into a collecting container. For workpieces, which are no foodstuff, e.g. made of metal, ceramic, or conductive plastic, or made of a combination thereof, the conductive liquid may be liquid metal, e.g. mercury, tin, lead, zinc, aluminum, each in liquid form, or a mixture thereof, or an aqueous or organic electrolyte solution. Generally, the conductivity is the conductivity for electric current.

It has shown that when the electrical conductivity of the liquid is at maximum ±75%, preferably at maximum ±50% of the conductivity exhibited by the workpiece, effective heating of the workpiece results. When the conductivity of the liquid is higher than the conductivity of the workpiece, the liquid can form a short circuit between the electrodes when the liquid forms a continuous phase between the electrodes, while when the conductivity of the liquid is lower, there is a high power dissipation in the liquid that contributes little or nothing to the heating of the workpiece along its longitudinal axis.

Herein, in accordance with the generally preferred embodiment, workpieces are also referred to as foodstuffs.

The electrodes are set up to be arranged at spaced, in particular terminal, areas of the workpieces, which are in particular foodstuffs, wherein at least the first electrode is set up to be arranged at a distance from the workpiece and to arrange conductive liquid in this distance, so that electric current, to which the electrodes are subjected, flows through the liquid, which fills the distance between electrode and workpiece, to the workpiece and the workpiece is heated by the passage of the current. The electrode is set up to arrange the conductive liquid in the distance by continuously conveying the liquid into this distance or by arranging a porous material provided with conductive liquid, in particular filled therewith, in the distance at the electrode, preferably arranged to convey conductive liquid continuously or batchwise into the porous material.

By applying electric current to the electrodes, the current is introduced into the workpiece and can flow between the electrodes through the liquid and through the workpiece, e.g. through at least a portion of the cross-section of the workpiece or foodstuff, when the liquid filling the distance between electrodes and workpiece contacts the workpiece at spaced areas along the cross-section and/or through at least a portion of the longitudinal extent of the workpiece or foodstuff when the liquid filling the distance between electrodes and workpiece contacts the workpiece at spaced areas along the cross-section.

The second electrode may have a structure as described with respect to the electrodes, in particular the first electrode, optionally being the same as the first electrode.

Alternatively, the second electrode can contact an open container filled with conductive liquid, be arranged in such a container, or be such a container in the open cross-section of which a part of the workpiece, in particular of a foodstuff, e.g. an end section, can be arranged. Therein, the second electrode can be set up to receive at least two workpieces, in particular foodstuffs, with their end portions, while the device is set up so that opposite end portions are each electrically contacted by liquid filling the distance to a first electrode. Such a second electrode is preferably arranged lower than first electrodes and optionally has an electrically near-earth potential.

Preferably, the device, in particular its holding device, is set up to hold a workpiece with its longitudinal extension or longitudinal axis arranged approximately vertically, while its ends are contacted by one electrode each. The electrodes are adapted to contact a workpiece disposed therebetween at opposite ends, the workpiece being held with its longitudinal axis arranged approximately vertically by the holding device. This is because when a workpiece is arranged with its longitudinal axis vertical, fluid discharged at the upper electrode will flow along the workpiece to its lower end. In doing so, the fluid will distribute evenly across the end face of the workpiece, allowing a uniform current to be delivered from the first electrode into the workpiece. Accordingly, it is preferred that workpieces have an approximately rotationally symmetrical shape about their longitudinal axis, e.g. a circular cross-section, which may be constant or variable along the longitudinal axis.

Alternatively, the device is set up such that the electrodes are adapted to contact a workpiece disposed therebetween at opposite ends, wherein a fluid circuit independent of the second electrode is provided at the first electrode or fluid circuits independent of each other are provided for the first electrode and for the second electrode. In this embodiment, each electrode is provided with a separate means adapted to bridge the distance between the electrode and the workpiece with fluid. For one of the electrodes, for example a first electrode arranged at a distance above a second electrode, this means may comprise an electrically non-conductive conduit for electrically conductive fluid connected to the first electrode and connected to an electrically insulated storage container, the conduit being adapted to convey the fluid into the distance between the electrode and the workpiece. For separating such a first feed line or first means for bridging the distance of the first electrode from the workpiece with electrically conductive liquid from the second electrode, the first means may comprise a collecting device for the liquid, which is connected to the storage container by a return conduit. A conveying device is preferably arranged in the return conduit, which is arranged to convey liquid collected by the collecting device into the storage container. The collecting device is preferably arranged below the first electrode. Optionally, the collecting device is arranged to cover an opening which is formed between the first electrode and the workpiece and can be bridged by liquid. When the first electrode is arranged at a distance from an upper end face of a workpiece, the liquid discharged from the first electrode then flows over the end face of the workpiece or foodstuff and is collected immediately thereafter by a collecting device, which may be a sleeve, and is then returned to the first electrode via the return conduit, the storage container and the conduit connected to the first electrode. Such a first means for filling and bridging the distance between the first electrode and a workpiece, in particular the upper end face thereof, separates the fluid supplied to the first electrode from the second electrode. The second electrode is arranged below the first electrode and is adapted to bridge the distance between the second electrode and the workpiece with electrically conductive liquid in that it is arranged in a container which may contain an electrically conductive liquid. The second electrode is located, for example, for receiving the lower end piece of the workpiece in a container with conductive liquid.

Thus, each electrical contact of electrode to workpiece is connected to an independent circuit or container of conductive fluid, which preferably have no electrical connection to each other. At least one conveying device is preferably arranged in a feed line connecting the storage container to the electrode and/or optionally in a return conduit connecting a collecting device to the storage container.

Preferably, the device has a holder for the workpieces, which are in particular foodstuffs, which is set up to hold the workpieces, in particular foodstuffs, at a distance from the first electrode and/or the second electrode. Preferably, the holder is arranged to hold the workpieces, in particular foodstuffs, with their extension along their longitudinal axis, also called long extension, approximately vertically, for example at most 20° from the vertical, or at an angle of at least 20° or at least 30° from the vertical to the horizontal. A holder may comprise or be a conveying device set up to bring the workpieces, in particular foodstuffs, into a position and hold them there in which position the first and/or the second electrode are arranged at a distance from the workpiece, in particular foodstuff, for which the device is set up so that the distance is bridged by the conductive liquid. The conveying device may generally be formed by counter-rotating and spaced-apart conveyor belts and/or conveyor rollers which between them convey the workpieces, in particular foodstuffs. Alternatively, the conveying device may be a gripper which on a robot arm is movable and positionable in a controlled manner.

The electrodes are connectable to opposite poles of a current source for the application of alternating current. The current source is arranged, for example, to apply current of alternating polarity to the electrodes, e.g. in the range of a voltage up to 1000 V, in the range of a current up to 100 A and with a frequency up to 100 kHz, preferably 10 to 50 kHz. Accordingly, the electrodes are connected to opposite poles of a current source which is arranged to apply current of an alternating frequency of 1 to 100 kHz, preferably 10 to 50 kHz, to the electrodes. Here, the frequency serves to prevent decomposition reactions of the foodstuff adjacent to the electrodes. The frequency is significantly below the frequency of microwaves or radio waves, so that heating is achieved by direct current flow between the electrodes through the liquid and the workpiece.

Optionally, at least the first electrode is enclosed by a sleeve that encompasses the portion of the conductive liquid projecting over the electrode, the sleeve preferably being adapted to allow a portion of the workpiece, in particular of the foodstuff, to project into the sleeve. To this end, the sleeve may be adapted to receive a surface portion, in particular an end portion, of the workpiece, in particular of the foodstuff. Preferably, the sleeve, for example a rubber sleeve is set up for elastically, sealingly and/or positively receiving a section, preferably an end section of the workpiece, in particular of a foodstuff. Such a sleeve can have the advantage of reducing the volume or flow rate of the conductive liquid by holding the liquid in the region between the electrode and the workpiece. For example, for sausage as a food product, the sleeve is adapted to receive a terminal section of the sausage. Such a sleeve may form a collecting device. In the process, in particular when the workpiece is a foodstuff, the distance to be filled by the conductive liquid (7, 20, 21) between an electrode and an end section of the workpiece may be enclosed by a sleeve. Therein, the conductive liquid can be taken up by the sleeve and fed into the storage container by means of a return conduit. Preferably, a collecting container is arranged below the electrodes to collect liquid that has been introduced into the distance for bridging between the electrode and the workpiece . Further preferably, the device has a return conduit for liquid from the collecting container to the at least one electrode whose distance to the workpiece is bridged by liquid. For avoidance of a current flow between the electrodes via a return conduit, the return conduit in the liquid-filled state may have a higher overall electrical resistance than the resistance of the workpiece between the electrodes. Therein, the return conduit can, for example, have a length whose resistance in the liquid-filled state has the higher electrical resistance. Such a length can be produced, for example, by sections of the return conduit that are spirally formed or executed in loops.

Alternatively, the electrical resistance of the return conduit can be increased by connecting at least one intermediate container between the collecting container and the return conduit, the connection of which to the collecting container and/or to the return conduit can be closable by means of a valve. In this embodiment, liquid can flow from the collecting container into an intermediate container while the connection or a valve to the return conduit is closed and this valve is opened only after the valve between the collecting container and the intermediate container is closed. Therein, the at least one intermediate container is set up to be alternately connected only to the collecting container or to the return conduit.

Another way to avoid unwanted shunt resistance due to conductivity of the conductive liquid circuit is to have separate liquid circuits, preferably for each electrode separately, which circuits are not connected to each other.

In general, it is preferred that conduits and containers for liquid as well as control elements connected to them, e.g. valves, and pumps are electrically non-conductive, e.g. the components that come into contact with liquid are made of insulating material, in particular electrically non-conductive plastic.

Foodstuffs can have a mass in a casing which consists of synthetic or natural material and optionally has pores. For example, the casing can consist of collagen and/or cellulose, a modified plastic, optionally fiber reinforced and/or optionally perforated. Generally, the casing is electrically conductive, optionally by way of pores in the casing.

Alternatively, foodstuff can have a surface that is optionally solidified by superficial heating of the food mass or consists of solidified food mass, wherein the food mass is not enclosed by an additional casing. Generally, the food mass can be sausage meat or a mixture of plant raw materials. For example, the foodstuff can have a length of about 0.1 m to 3 m with a diameter of 2 cm to 30 cm.

Preferably, the foodstuff is sausage, e.g. with a surface of solidified sausage meat or with a casing around the sausage meat.

In the process, the workpieces, in particular foodstuffs, are electrically contacted at spaced-apart surface sections, e.g. end sections, by a first electrode which is arranged at a distance from the surface section, the distance being bridged by conductive liquid which is preferably conveyed continuously or batchwise into the distance. Optionally, a porous material is arranged at the electrode to at least partially hold the liquid.

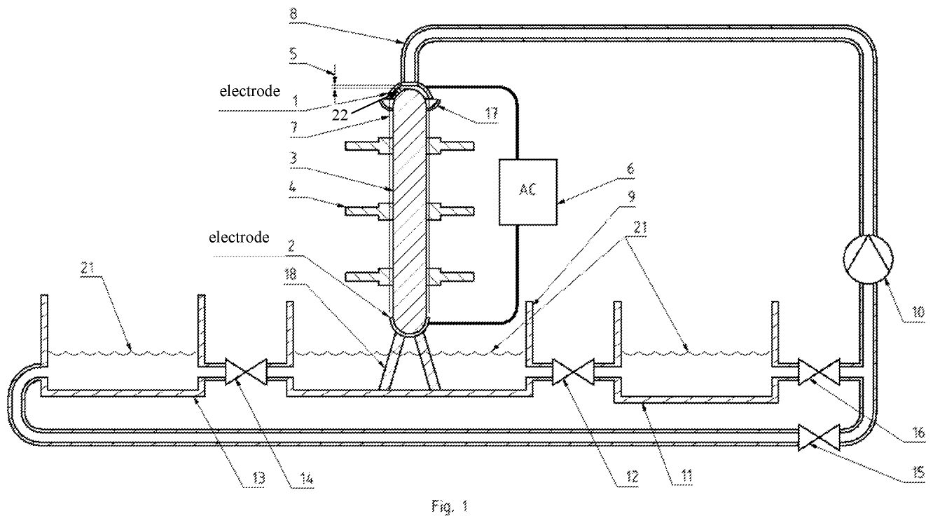

FIG. 1 shows a sausage-shaped foodstuff representative of a workpiece 3 , which is clamped and held in a vertical arrangement by a holding device 4 on e.g. 3 areas spaced along its length. A first electrode 1 is arranged at a distance 5 from the workpiece 3 and is connected to an electrical energy source 6. The first electrode 1 is connected, for example by means of a feed line 8, to an electrically insulated storage container 11, 13 for conductive liquid 21, 7 and is arranged to supply the liquid 7 continuously or batch-wise, for example clocked, over the distance 5. Therefore, the liquid 7 bridges the distance 5 from the electrode 1 to the workpiece 3. The liquid 7 can, subsequently after passing the distance run along the surface of the workpiece 3 and run down from the workpiece 3. In the embodiment shown here, the storage container 9, which is arranged below the electrodes 1, 2, forms a collecting container for the liquid.

The second electrode 2, which is electrically connected to the opposite polarity of the current source 6, is arranged opposite to the first electrode 1 on the workpiece 3. Generally, a sleeve 17 can cover the area of the distance 5 and can cover an end portion of the workpiece 3 without damaging its surface. A pump 10 is arranged in the return conduit 8 to convey the liquid to the first electrode 1.

Each holding device 4 can be set up to position the workpiece 3 with its opposite end sections at a distance 5 from electrodes 1, 2 and/or to move it past them, wherein the electrical contact from the electrodes 1, 2 to the workpiece 3 is established over the distance 5 by the conductive liquid 7, 20, 21. The holding device 4 can be, for example, a gripper that is set up to position one workpiece 3 at a time in the area between the electrodes 1, 2.

In the embodiment shown, the second electrode 2 can be shell-shaped and can receive and support an end section of the workpiece 3. Liquid 7, which emerges from the distance 5 and runs along the workpiece 3, bridges a distance between the second electrode 2 and the workpiece 3 and establishes the electrical contact between them. The second electrode 2 can be held by supports 18 above the collecting container 9.

FIG. 1 shows an embodiment in which an intermediate container 11 and 13 is connected between the collecting container 9, which also serves as a storage container 9, and the return conduit 8, wherein a valve 12, 14 is arranged between the collecting container 9 and the intermediate container 11, and a further valve 15, 16 is arranged between the intermediate container 11 and 13 and the return conduit 8, which are alternately opened in order to interrupt an electrical connection by the liquid 7, 20, 21 through the collecting container 9 to the conveying system 8, 10. For a continuous delivery of liquid 7, 20, 21 from the collecting container 9 through the return conduit 8, the device can comprise another intermediate container 13, which can be alternately connected to the collecting container 9 and the return conduit 8 by valves 14, 15. Preferably, the valves 12, 14, 15, 16 as well as the collecting container 9 and the intermediate containers 11, 13 as well as all lines for liquid 7, in particular the return conduit 8, are not or only slightly electrically conductive. Optionally, a porous material is attached to one electrode or to both electrodes 1, 2, in particular only to the first electrode 1, which holds the liquid 7, 20, 21 inside the distance 5.

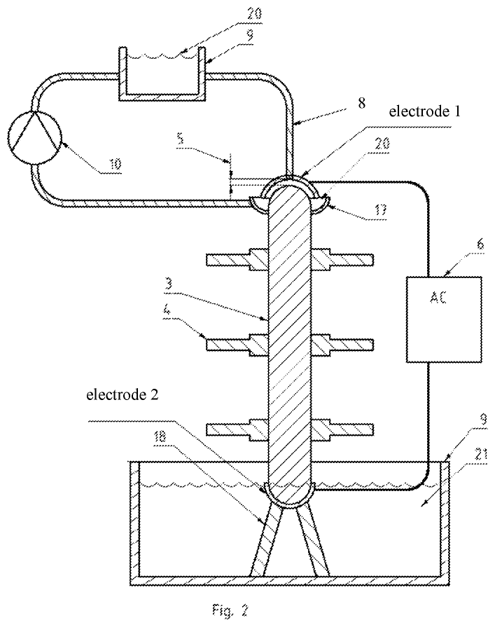

FIG. 2 shows a further embodiment of the invention. A sausage-shaped foodstuff 3 is clamped and held in a vertical arrangement by a holding device 4 at, for example, 3 areas spaced along its length. A first electrode 1 is arranged at a distance 5 from the workpiece 3 and is connected to an electrical energy source 6. The first electrode 1 is connected, for example, by means of a feed line 8 together with a pump 10 and a sleeve 17, which forms a collecting device, for conductive liquid 20 and is arranged to supply the liquid 20 continuously or in a clocked manner across the distance 5. The liquid 20 preferably does not flow along the surface of the workpiece 3 due to the sleeve-like collecting device 17, which is at the electrical potential of the first electrode 1, but circulates in the circuit 8 of the pump 10. A return conduit 8 directs the liquid from the collecting device 17 into the intermediate reservoir 9.

The second electrode 2, which is electrically connected to the opposite polarity of the current source 6, is arranged opposite to the first electrode 1 on the workpiece 3 and is preferably located in a storage container 9 containing conductive liquid 21 which is at the electrical potential of the second electrode 2.

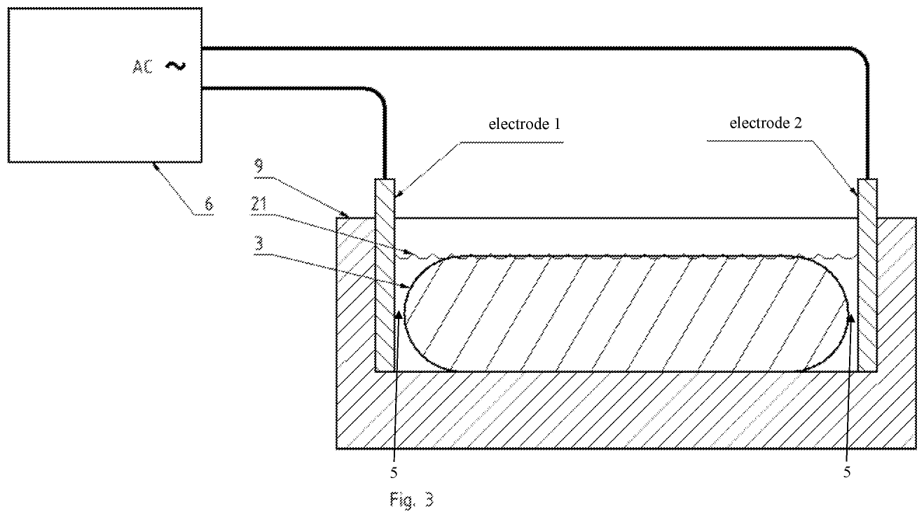

FIG. 3 shows an embodiment in which a first electrode 1 and a second electrode 2, each electrically connected to the current source 6, are arranged at a distance from one another and a foodstuff 3 is arranged between the electrodes 1, 2, at a distance 5 each from the electrodes 1, 2. The distance 5 is filled and bridged by conductive liquid 21. It has shown that the current flow through the foodstuff 3, which is preferably sausage, leads to heating when preferably the conductivity of the conductive liquid 21 is at most 50% lower than the conductivity of the foodstuff Therein, the liquid 21 can fully enclose or cover the foodstuff 3, or cover the foodstuff 3 only proportionally. The foodstuff can generally, in particular in this embodiment, be arranged in a container, referred to herein as a storage container 9 or generally as a collecting device, wherein the foodstuff is covered over its entire cross-section by the conductive liquid.

### Reference Sign:

1 first electrode

2 second electrode

3 workpiece, foodstuff

4 holding device

5 distance

6 current source

7 conductive liquid

8 return conduit

9 storage container

10 conveying device, pump

11 intermediate container

12 valve

13 intermediate container

14 valve

15 valve

16 valve

17 collecting device, e.g. sleeve

18 support

20 conductive liquid

21 conductive liquid

22 porous material

1. A device for heating at least one workpiece, comprising a first electrode configured to be arranged at a distance from a first end of the at leas tone workpiece, a conductive liquid arranged to bridge the distance, and a second electrode configured to be arranged at the second end of the at least one workpiece opposite to its first end along its longitudinal axis, wherein the conductive liquid has a conductivity which deviates from the conductivity of the workpiece by a maximum 75%.

2. The device according to claim 1, comprising a storage container and a feed line, the feed line being arranged to feed the conductive liquid continuously or intermittently from the storage container into the distance.

3. The device according to claim 1, comprising a storage container, the first and second electrodes being arranged at its opposite ends along its longitudinal axis, wherein the storage container is configured to receive the at least one workpiece with its longitudinal axis along the longitudinal axis of the storage container.

4. The device according to claim 1, wherein the first electrode is configured to be arranged at the first end of a single workpiece and the second electrode is configured to be arranged at the second end of the same workpiece.

5. The device according to claim 3, comprising a collecting structure arranged to cover the distance and to receive conductive liquid, the collecting device being connected to the storage container (9) by means of a return conduit (8).

6. The device according to claim 1, wherein the second electrode is configured to be arranged along a surface of the workpiece above a storage container, the device comprising a return conduit for liquid from the storage container to the first electrode.

7. The device according to claim 1, comprising a holding device configured to place a workpiece between the electrodes with vertical alignment of the longitudinal axis of the workpiece.

8. The device according to claim 1, comprising a porous material filled with the conductive liquid in the distance.

9. The device according to claim 1, comprising an electrically insulated storage container connected to the first electron by an electrically non-conductive conduit arranged to convey the conductive liquid into the distance.

10. The device according to claim 1, comprising a sleeve enclosing the distance.

11. The device according to claim 1, wherein the workpiece is a foodstuff, the device comprising a conductivity sensor mounted in a conduit arranged to deliver liquid to the first electrode, and a metering device controlled in dependence on the signal of the conductivity sensor for the addition of salt, brine or water to the liquid, the metering device being controlled to adjust the conductive liquid to a conductivity which deviates by at maximum 50% from a predetermined conductivity corresponding to the conductivity of the foodstuff.

12. A method for heating individual workpieces in a device according to claim 1, comprising arranging a workpiece between the two electrodes and applying an electric current to an individual workpiece through the two electrodes and the conductive liquid, wherein the first electrode is arranged at a distance from a first end of the workpiece and the conductive liquid bridges the distance, and the second electrode is arranged at the second end of the workpiece lying opposite to the first end along its longitudinal axis.

13. The method according to claim 12, comprising continuously delivering the conductive liquid from an electrically insulated storage container through an electrically non-conductive conduit into the distance.

14. The method according to claim 12, comprising retaining the conductive liquid in a porous material arranged between and the first electrode and the workpiece.

15. The method according to claim 12, wherein the at least one workpiece is a foodstuff and the conductive liquid has a conductivity that deviates by at maximum 50% from the conductivity of the foodstuff.

16. Method according to claim 15, wherein a surface is not touched by the electrodes and that the distance is enclosed by a sleeve.
